(19) United States
(12) Patent Application Publication
(10) Pub. No.: US 2009/0197750 A1
(43) Pub. Date: Aug. 6, 2009

(54) PROCESS AND APPARATUS FOR PRODUCING TOBACCO BAGS

(76) Inventors: Frank Beckmann, Aumuhle (DE); Andreas Storcks, Hamburg (DE); Burkard Roesler, Blender (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/364,236

(22) Filed: Feb. 2, 2009

(30) Foreign Application Priority Data
Feb. 5, 2008 (DE) 102008007752.6

(51) Int. Cl. B31B 19/14; B31B 1/16; B31B 1/36; B31B 1/64

(52) U.S. Cl. 493/11; 493/190; 493/248; 493/235

(57) ABSTRACT

For the continuous production of tobacco bags from a sheet-material web (19), the latter is, in the first instance, folded in the region of a folding device (30) to form a continuous web leg (20) corresponding to a pocket of the bag. The web (19) prepared in this way is directed through a sealing subassembly for the purpose of providing transversely directed connecting seams as a lateral boundary to the pockets of successive bags. The sealing subassembly (31) is arranged in an upright position with sealing devices one beneath the other. The web (19) is directed through the sealing subassembly (31) in an upright plane and is largely free of tensioning during the sealing operation.

### STATEMENT OF RELATED APPLICATIONS

This application claims the benefit under 35 USC 119 of German patent application number 10 2008 007 752.6 having a filing date of 5 Feb. 2008, which is incorporated herein in its entirety by this reference.

### BACKGROUND OF THE INVENTION

1. Technical Field

The invention relates to a process for producing (tobacco) bags from sheet material having a pocket which is formed by folding, is bounded by side seams and has an opening and a closure flap, in particular a fold-over flap, it being the case that, in order to produce the bags, a continuous (sheet-material) web is folded over in the longitudinal direction to form a web leg, then transversely directed connecting seams are provided in the region of the web leg and, finally, the bags are severed from the web by transversely directed severing cuts in the region of the (double-width) connecting seams.

Such bags, in particular configured as fold-over bags, serve, in particular, for accommodating a portion of cut tobacco. The opening is usually closed by a closure seam which can be opened by the user. The fold-over flap is folded around the pocket and fixed by means of tape.

2. Prior Art

In the case of the prior art (DE 34 46 409 A1), the sheet-material web is drawn off from a reel, folded as it is transported, with the web leg being provided in the process, and then conveyed through a sealing station. In the region of the latter, three connecting seams are provided simultaneously in the region of the web leg. Thereafter, the bags are severed from the web by virtue of severing cuts being provided in the region of the connecting seams. The individual bags are transferred to a bag turret in order for the pockets to be filled. The sheet-material web is transported in an upright plane in a horizontal conveying direction. It is also the case that the sealing devices, a severing device and the bag turret are active with the sheet-material web and/or the bags in an upright position. This means that the apparatus requires a considerable amount of space.

### BRIEF SUMMARY OF THE INVENTION

The object of the invention is to avoid disadvantages of the prior art, in particular to propose a process which makes it possible to have a compact, high-performance apparatus for producing the bags, while maintaining sufficient quality of the products.

In order to achieve this object, the process according to the invention is characterized in that the connecting seams are provided in the region of an upright portion of the (sheet-material) web by sealing devices arranged one above the other.

Accordingly, the operation of providing the connecting seams directed transversely to the sheet-material web is shifted into the region of an upright conveying section of the web. This makes possible a high-performance sealing station which requires only a small base surface area. It is also an important factor that the sheet-material web can be provided in a largely tensioning-free manner for the sealing devices in the region of the sealing station.

It is also important that sensors or sensing devices provide for precise positioning of the sheet-material web in the region of the upright sealing station. In the case of materials which are sensitive to tensioning, e.g. PE sheet materials, a compensating device for compensating for changes in length of the web is additionally provided in the region of the sealing station.

The design of the sealing devices is also special, as is the guidance of the sheet-material web upstream of the sealing station, in the region of the same and following it.

### BRIEF SUMMARY OF THE DRAWINGS

Further details of the invention will be explained more specifically hereinbelow with reference to the drawings, in which:

FIG. 1 shows a perspective illustration of a (tobacco) bag in the closed position.

FIG. 2 shows, likewise in perspective, a portion of a (sheet-material) web for producing bags according to FIG. 1.

FIG. 3 shows a simplified, perspective illustration of an installation for producing, filling and closing (tobacco) bags.

FIG. 4 shows the apparatus according to FIG. 3 in a transverse view according to arrow IV in FIG. 3.

FIG. 5 shows a side view of the apparatus according to arrow V in FIG. 3.

FIG. 6 shows, on an enlarged scale, a detail of a sealing station.

FIG. 7 shows a detail corresponding to FIG. 6, but relating to another exemplary embodiment.

FIG. 8 shows an illustration analogous to FIG. 5, but relating to another embodiment of the sealing station.

FIG. 9 shows a transverse view or plan view of the sealing station according to arrow IX in FIG. 8.

FIG. 10 shows an illustration analogous to FIGS. 5 and 8 for a further exemplary embodiment of the sealing station.

FIG. 11 shows, on an enlarged scale, a detail XI of the sealing station in FIG. 8.

FIG. 12 shows the detail according to FIG. 11 with devices in a different position.

FIG. 13 shows the detail according to FIGS. 11 and 12 with devices in yet another position.

### DETAILED DESCRIPTION OF PREFERRED EMBODIMENTS

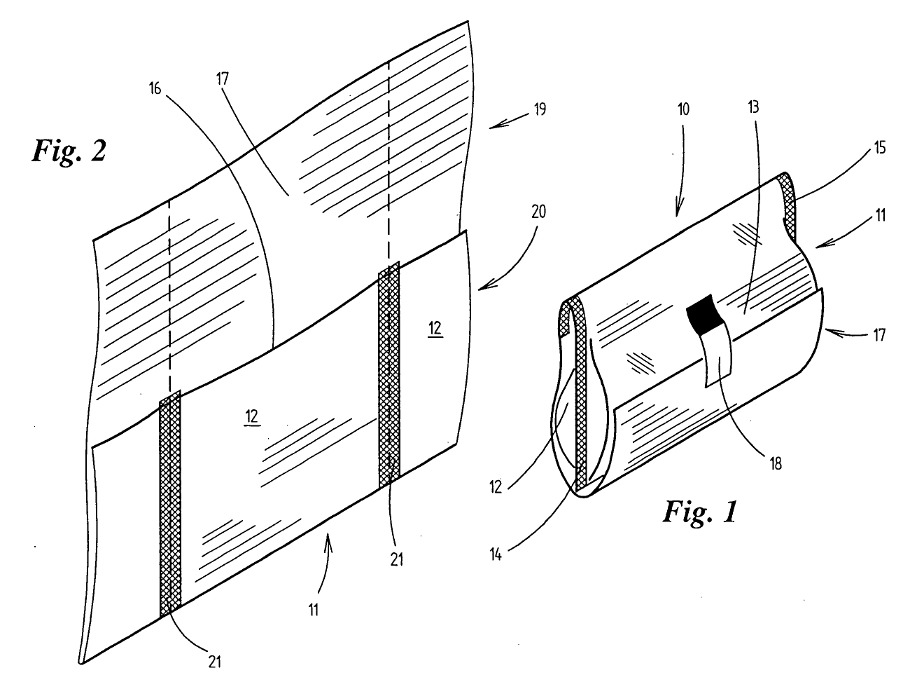

FIG. 1 shows an example of a bag 10 made of thin packaging material, in particular of (thermally sealable and/or weldable) sheet material. The bag 10 comprises a single-piece, essentially rectangular, elongate blank which, on account of being folded correspondingly, forms a pocket 11 for the pack contents. The pocket 11 is bounded by a front pocket wall 12 and a rear pocket wall 13, which are connected to one another by side seams 14, 15. An opening 16 serves for filling the pocket 11 and for removing the contents. The rear pocket wall 13 is extended beyond the opening 16 and forms a closure flap or a fold-over flap 17. According to FIG. 1, with the bag filled and the opening 16 closed by a closure strip, this fold-over flap has been folded around the pocket such that an end region of the fold-over flap 17 butts against the rear pocket wall 13 and is fixed in a releasable manner thereon by means of tape 18.

The bags 10 are obtained by being severed from a continuous web 19 of sheet material or some other suitable packaging material. The web 19 is folded in the longitudinal direction to form a web leg 20 during continuous transportation. This web leg defines the pocket 11. The web leg 20 is fixed on the web 19 by transversely directed connecting seams 21. A transversely directed severing cut is executed centrally in the region of the connecting seams 21 to produce completed bags 10. The connecting seam 21 is double the width of a side seam 14, 15.

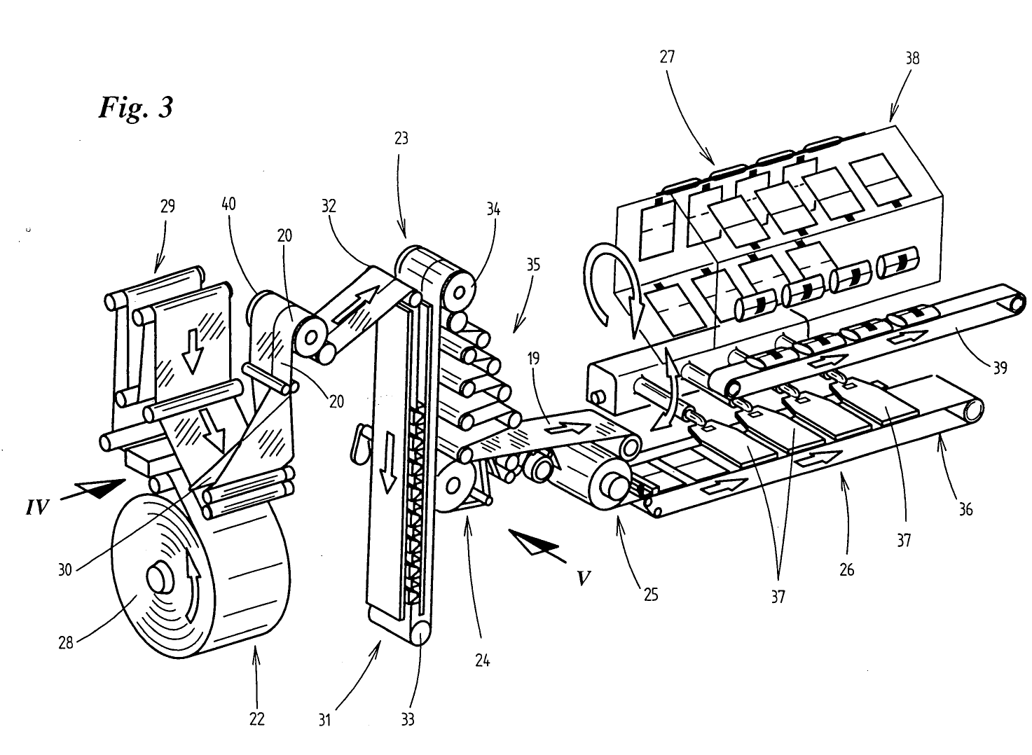

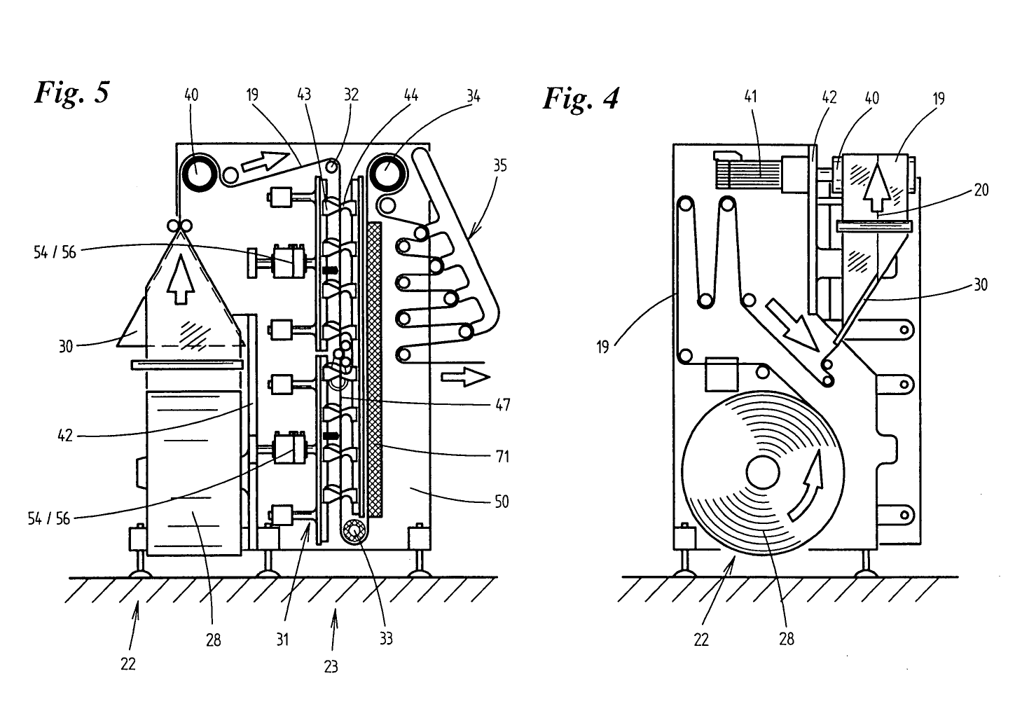

The bags 10 are produced, and processed further, in a compact, high-performance apparatus according to FIG. 3. This has a plurality of stations, namely a sheet-material station 22, a sealing station 23, a tape station 24, a severing station 25, a transfer station 26 and a filling and closing station 27. The devices and/or subassemblies of the individual stations are arranged in a configuration which is optimal in terms of functioning and in respect of the amount of space required. The sheet-material station 22 contains a reel 28 for the sheet-material web 19 with a horizontal axis which extends in the main conveying direction. Accordingly, the web 19 is drawn off from the reel 28 transversely to this conveying direction and guided via a first compensating pendulum arrangement 29 into the region of a folding device 30. The latter is arranged between deflecting rollers such that, during transportation, the continuous web leg 20 is formed by folding and, at the same time, the web 19 prepared in this way is deflected into the main conveying direction.

The folded web 19 then passes into the region of the sealing station 23 with an upright sealing subassembly 31. Accordingly, the web 19 is guided through the sealing subassembly 31 in a vertical plane. The conveying direction extends downwards from a top deflecting roller 32 on the inlet side of the sealing subassembly 31 to a bottom deflecting roller 33 on the outlet side. Between the deflecting locations, the web 19 is transported cyclically. At least during the sealing operation, that is to say during the operation of providing transversely directed connecting seams 21, the web is kept largely free of tensioning and driving influences.

The bottom deflecting roller 33 deflects the web 19, once it has left the sealing subassembly 31, in the opposite conveying direction, namely in the upward direction, to be precise directly adjacent, and parallel, to the sealing subassembly 31. Deflection at the top is provided by a deflecting roller 34 which, at the same time, is a drive roller for the web, to be precise in particular with a servo drive. The deflecting roller 34 is arranged approximately level with the inlet of the web 19 into the sealing subassembly 31.

Following the deflecting roller 34, the web 19 runs over a further, second compensating pendulum arrangement 35. This compensates for the differences in movement of the web 19 in the region of the sealing subassembly 31, on the one hand, and of the downstream subassemblies, on the other hand.

The tape station 24 follows. In the region of the latter, the tape 18, that is to say the adhesive-bonding closure strip for the bag 10 is provided in the correct position on the web 19. In this station, it is also possible to provide further blanks on the web 19, for example printing carriers (coupons) or so-called stickers for fixing inserts such as cigarette paper. This station is followed by the severing station 25 with a severing blade for severing the bags 10 from the web 19, the severing cut being executed centrally in each case in the region of the connecting seam 21.

The bags 10 are transferred to a bag conveyer 36 which conveys the bags 10 in continuation of the main direction and provides them for transfer to the filling and closing station 27. By means of transfer devices 37, in each case a plurality of, for example four, bags 10 on the bag conveyer 36 are simultaneously gripped, raised up and transferred to a bag turret 38. The latter transports the bags 10 with rotary action along a movement path transverse to the main conveying direction, the bags 10 being filled and closed in successive stations. The completed bags 10 are removed by a removal conveyer 39.

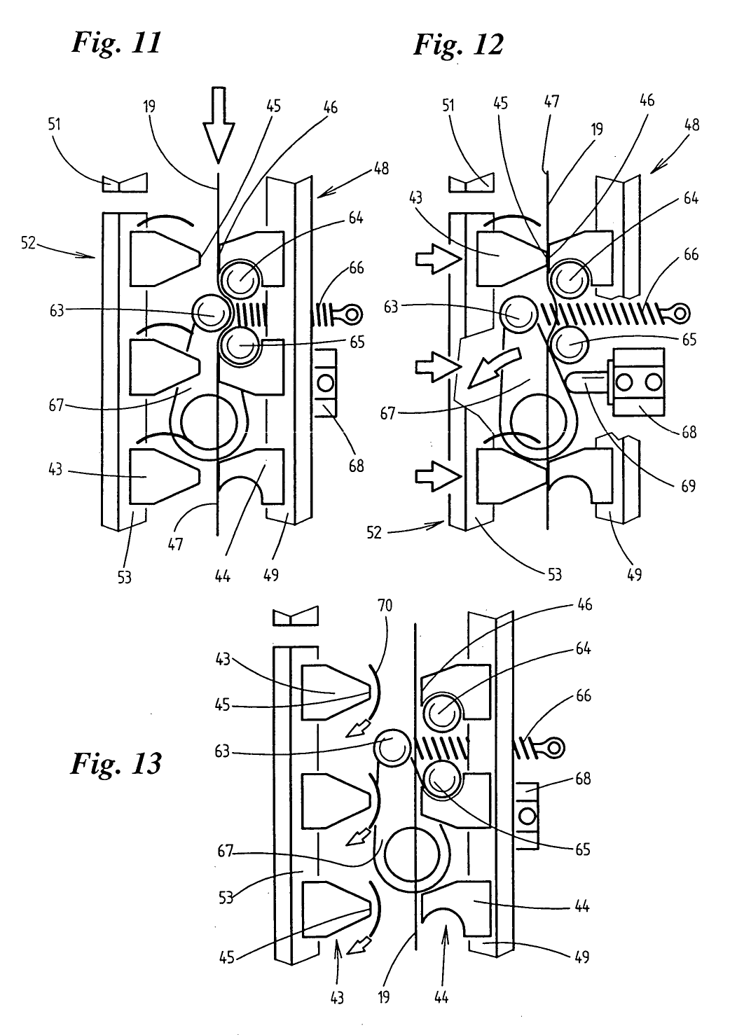

The design of the sealing station 23 or the sealing subassembly 31 is special. The web 19, following the folding device 30 formed as a folding diverter or folding plate, is gripped by a deflecting roller 40 which is arranged above the folding device 30, is designed as a drive roller and is driven by a motor, in particular a servo motor 41. The deflecting roller 40 is mounted (along with the servo motor 41) on an upright carrying wall 42. A downstream deflecting roller 32 directs the web 19 into a vertical plane with downwardly directed transportation between the sealing and/or welding devices which are positioned in pairs in the region of the sealing subassembly 31, on both sides of the web 19, and interact cyclically. The welding and/or sealing devices are sealing jaws 43 on the one side, and abutment jaws 44 on the other side of the web 19. The associated jaws 43, 44 are arranged in the same horizontal plane in each case and can be moved cyclically relative to one another between a starting position (e.g. FIG. 11) and a welding and/or sealing position with abutment against the web 19 (e.g. FIG. 12). The sealing devices 43, 44 are elongate and/or in the form of crosspieces or bars with a converging cross-sectional shape, this producing a comparatively narrow sealing surface 45, in particular of the width of the connecting seams 21. The abutment jaws 44 are designed with a somewhat wider abutment surface 46.

The arrangement and design of the sealing subassembly 31 makes it possible for a plurality of sealing devices to be arranged in the region of an upright portion 47 of the web 19. Eight sealing devices, or eight sealing jaws 43 with abutment jaws 44, are set up in the case of the exemplary embodiment according to FIG. 5. Accordingly, in an operating or sealing cycle, eight connecting seams 21, and therefore a corresponding number of bags 10, can be defined on the web 19. The pairs of sealing jaws 43 and abutment jaws 44 are arranged one above the other at a spacing corresponding to the dimensioning of a bag 10. The sealing jaws 43, on the one hand, and the abutment jaws 44, on the other hand, are arranged on separate carriers. The (unheated) abutment jaws 44 are provided on a common carrier 48 which is continuous over the entire height and is of plate-like design. The abutment jaws 44 are fastened on retaining devices of the carrier 48, to be precise such that displacement—following release of connecting means—on the carrier 48 is possible in order to allow different relative positioning of the sealing devices. In the present case, two connecting rails 49 are provided on the carrier 48 and these, on the one hand, provide for guidance of the abutment jaws 44 and, on the other hand, in conjunction with retaining means, allow fixing in any desired position. The carrier 48 is provided on a carrying framework (not shown specifically), in particular on an upright main plate 50.

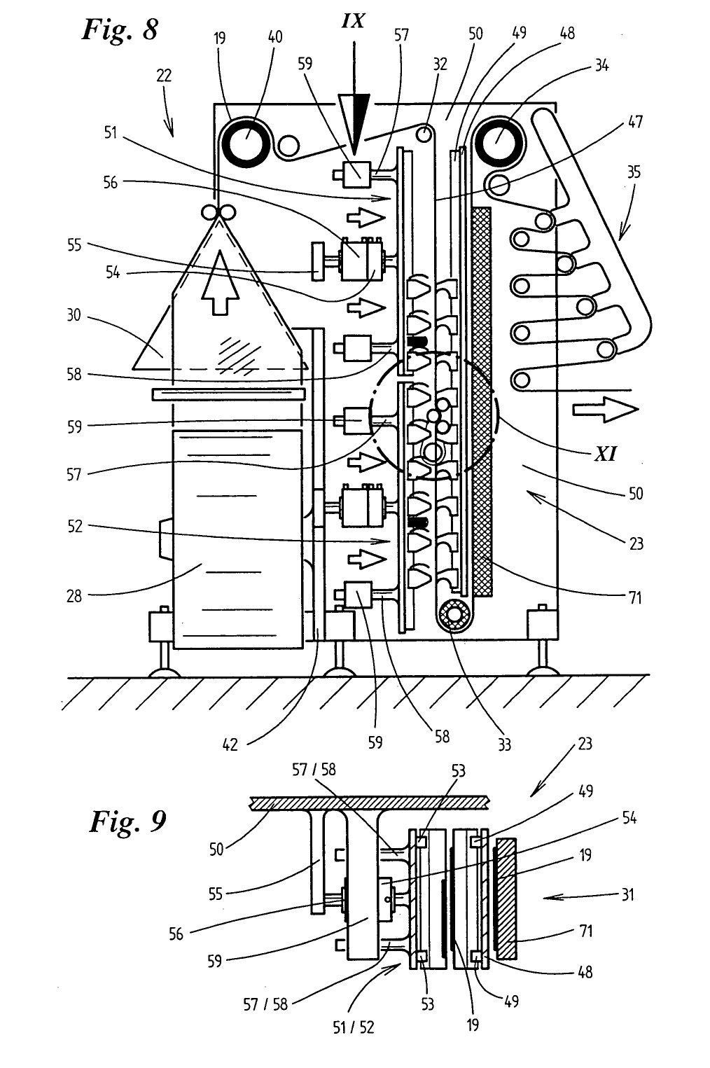

The sealing jaws 43 are provided in a similar manner on upright carrying devices, to be precise on (two) jaw carriers 51, 52, which are aligned vertically one above the other. In the case of the examples shown, the jaw carriers 51, 52 are the same size, in which case they are suitable for accommodating the same number of sealing devices or sealing jaws 43. In the case of the exemplary embodiment of FIG. 5, four sealing jaws 43 are arranged on each jaw carrier 51, 52. The adjacent sealing jaws 43 of the two jaw carriers 51, 52, that is to say half-way up the sealing subassembly 31, are appropriately positioned in order for the spacing to correspond to the dimensioning of the bag 10 which is to be produced. The jaw carriers 51, 52 are likewise of plate-like design with connecting rails 53 for fixing the devices in an adjustable manner. Depending on the size of the bags 10 which are to be produced, the sealing devices 43, 44 may be distributed in a formation which differs from that in FIG. 5, as shown for example in FIG. 8 with a plurality of sealing devices in the bottom region of the sealing subassembly 31.

In the case of the exemplary embodiments illustrated, the sealing subassembly 31 is arranged such that the abutment jaws 44 are arranged in a fixed manner. Accordingly, the carrier 48 cannot be moved. The necessary movements for executing the sealing cycle are performed here exclusively by the sealing jaws 43 and/or by the jaw carriers 51, 52. The two jaw carriers 51, 52 are assigned separate actuating devices for executing back and forth transverse movements until abutment against the web 19 is achieved. An actuating device, namely a cylinder 54, is provided on the free rear side of each plate-like jaw carrier 51, 52. This cylinder is configured for a displacement which corresponds to the movement of the sealing devices between a starting position (FIG. 11) and a sealing position (FIG. 12). The actuating cylinders 54 each act half-way up, that is to say centrally on, the jaw carriers 51, 52. Each cylinder 54 is connected to a holder 55 which, for its part, is provided on a carrying framework or on the main plate 50.

The sealing subassembly 31 is designed such that the heated devices, that is to say the sealing jaws 43, can additionally be moved into a rest position at a greater spacing apart from the web 19 (FIG. 13). This position is activated when it is necessary to interrupt operation of the machine and the situation where the web 19 is subjected to the heat emanating from the sealing jaws 43 is to be avoided. In order to execute this additional or alternative movement, a further actuating cylinder is provided and/or each actuating cylinder 54 is provided with an additional cylinder 56 which provides for greater displacement of the jaw carriers 51, 52. In order for correct parallel movement of the sealing jaws 43 and/or of the jaw carriers 51, 52 to take place, these are supported and/or retained by at least two guide rods 57, 58 in corresponding fixed guides 59, in particular ones provided on the main plate 50.

In the case of the present exemplary embodiment (FIG. 9), the welding and/or sealing tools, that is to say the sealing jaws 43, on the one hand, and abutment jaws 44, on the other hand, extend over the entire width of the carrying devices 48, 51, 52 and thus over the entire width of the (folded) web 19. The sealing jaw 43 is split in functional terms, that is to say into a heated jaw part and a non-heated jaw part. These may be separated from one another by an air gap or by appropriate insulation, in which case heat is transmitted to the web 19 only in the region of the web leg 20, but the web 19 is fixed by the devices over its entire width. As an alternative, the devices 43, 44 may be designed to be shortened to the width of the web leg 20.

The deflecting rollers 32 and 33 ensure that the web 19 is directed through the sealing subassembly 31 with certain relative positioning, that is to say directly adjacent to the fixed abutment jaws 44 (FIG. 13). The web leg 20 is preferably arranged on the side which is directed towards these abutment jaws 44, in which case the heat is transmitted from the rear side of the web 19.

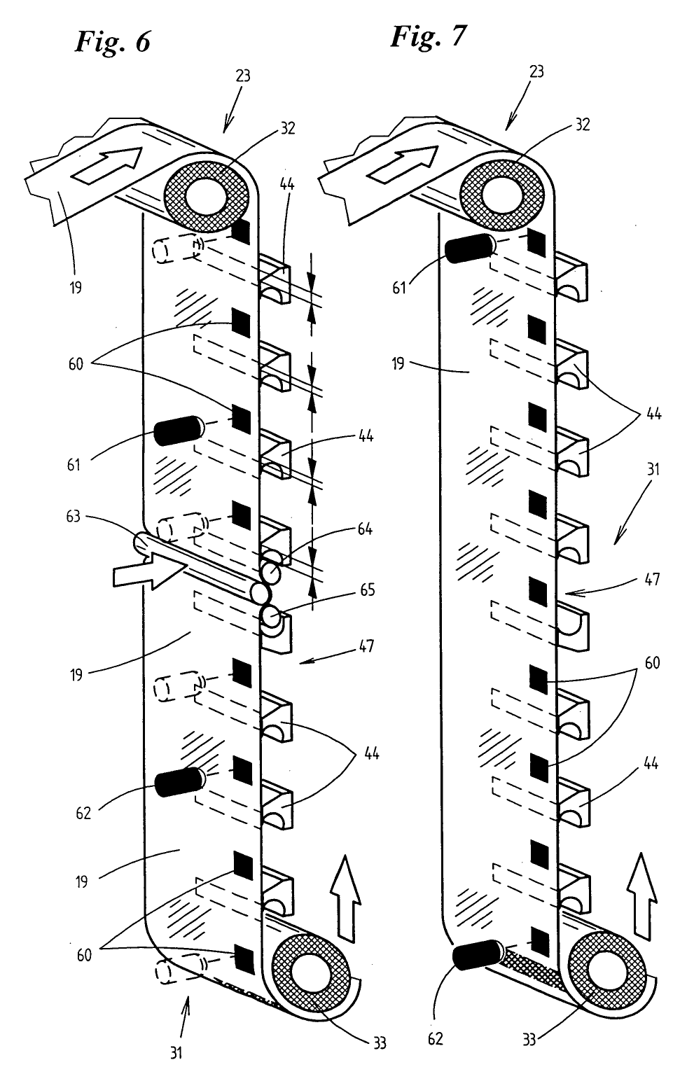

The sealing subassembly 31 is provided with monitoring devices which ensure precise positioning of the web 19 in the region of the welding and/or sealing devices. These are intended to ensure, even in the case of materials which are sensitive in relation to (longitudinal) tensioning, precise positioning of the connecting seams 21 and thus precise dimensioning of the bags 10. The position of the web 19 between the deflecting rollers 32 and 33 is monitored by sensors. In the case of the present exemplary embodiment, markings, in this case printed marks 60, are provided on the web 19. These are spaced apart from one another by spacings corresponding to the spacings between the connecting seams 21 which are to be provided. Stationary sensors or printed-mark readers 61, 62 sense the printed marks 60 and thus determine the position of the web 19. In the case of the exemplary embodiment according to FIG. 6, two sensors or printed-mark readers 60 are installed, to be precise in each case approximately centrally in relation to the two groups of sealing jaws 43—corresponding to the jaw carriers 51, 52. As an alternative, two such printed-mark readers 60 may be installed for each group of sealing jaws 43, that is to say with top and bottom printed-mark readers 61, 62 in positions indicated by dashed lines. The printed-mark readers 61, 62 are adjustable, to meet requirements or as predetermined by the spacings between the connecting seams 21. The printed marks 60 are predetermined during production of the sheet material and are geared to the respective dimensioning of the bags 10. If incorrect positioning of the web 19 is detected in the region of the web portion 47, this can be compensated for via the top and/or bottom deflecting rollers 32, 33, the latter being designed as drive rollers, in particular with a servo drive. In the case of the exemplary embodiment according to FIG. 6, the printed-mark readers 61, 62 are distributed such that a sensor 61 is positioned centrally in each case in the region of the top four sealing jaws 43 and abutment jaws 44 and a sensor 62 is positioned likewise centrally in the case of the bottom four jaws 43, 44, to be precise preferably centrally between two successive jaws 43, 44. As an alternative, it is possible to select the distribution of four sensors which is illustrated by dashed lines, in each case one sensor being positioned at the top and bottom in the region of the deflecting rollers 32, 33 and the rest of the sensors being arranged at equal spacings. In the case of the embodiment according to FIG. 7, which is preferably suitable for a web with a low level of expansion capability, a respective sensor 61, 62 is located directly beneath and above the deflecting rollers 32, 33.

Furthermore, the sealing subassembly 31 may be provided with a compensating device in order to compensate for any possible inaccuracies in the web portion 47 on account of corresponding measurements. This applies, in particular, in the case of materials which are sensitive to tensioning. The compensating device comprises at least one deflecting device which deflects the web 19 laterally to a slight extent in order to reduce the effective length. It is advantageous to have a compensating roller 63 which is directed transversely to the web 19 and, by axis-transverse movement, causes the web 19 to be deflected sideways (FIG. 11). The compensating roller 63 preferably interacts with abutment rollers 64, 65, which are mounted in a fixed state on the opposite side of the web 19 and, on account of the spacings, cause the web 19 to be deflected. The moveable compensating roller 63 here can be moved by an actuating device out of the starting position according to FIGS. 12 and 13—at a spacing apart from the web 19—into the deflecting position (FIG. 11). This actuating device is a (tension) spring 66, which forces the compensating roller 63 constantly into the deflecting position with abutment against the fixed abutment rollers 64, 65. In order to execute the movements, the compensating roller 63 is arranged on a lever 67 which can be pivoted about a fixed bearing by the action of the spring 66. A (pneumatic) cylinder 68 serves as an oppositely directed actuating device for the compensating roller 63, or the lever 67, and the piston 69 of this cylinder can be extended towards the lever 67 in order to pivot the latter, that is to say out of the deflecting position into a retracted position.

The compensating device 63, 64, 65 is preferably used such that, in the event of an offset being detected between a printed mark and the desired position of the web in the region of the jaws 43, 44, the compensating roller 63 is moved into the deflecting position according to FIG. 11. FIG. 6 shows the case where the spacings between the printed marks are (slightly) greater than the spacings between the connecting seams 21 which are to be produced. The compensating device 63 corrects the relative positioning of the web 19 in the region of the bottom (four) jaws 43, 44 since, when the web 19 is at a standstill, the bottom sub-region is moved upwards slightly. This eliminates the differences in position. In the top part, the deviations are not as great and, as such, are accepted.

The details according to FIGS. 11 to 13 show a further special feature. In order to protect the web 19 against the influences of heat in the event of a relatively long standstill or interruption to operation, protective shields 70 are moved in front of the sealing jaws 43, that is to say on the side which is directed towards the web 19, when the sealing jaws 43 are in the correspondingly retracted position (FIG. 13). The protective shields 70 are curved mouldings made of heat-repellent material. The protective shields 70 are mounted in a laterally pivotable manner and, on account of an appropriate control signal, can be moved into the protective position according to FIG. 13 or back into the starting position according to FIGS. 11 and 12 alongside and/or above the sealing jaws 44.

As a further measure to improve the quality of the bags 10 and/or of the connecting seams 21, provision is made for the web 19 to be cooled following the operation of the connecting seams 21 being sealed. According to FIG. 5, the bottom deflecting roller 33 for the web 19 is designed as a cooling roller, in particular configured with a cooling medium (air, liquid) which flows through the hollow roller. In addition, or as an alternative, a cooling device for the web 19 may be installed immediately following the sealing subassembly 31. According to FIG. 5, an upright cooling plate 71 is arranged on the rear side of the sealing subassembly 31. It is also possible for this cooling plate to have a cooling medium flowing through it or to be designed in some other way. The cooling plate 71 here is located at a small spacing apart from, and parallel to, the carrier plate 48. The web 19 is transported upwards through an upright gap between the sealing subassembly 31 and cooling plate 71.

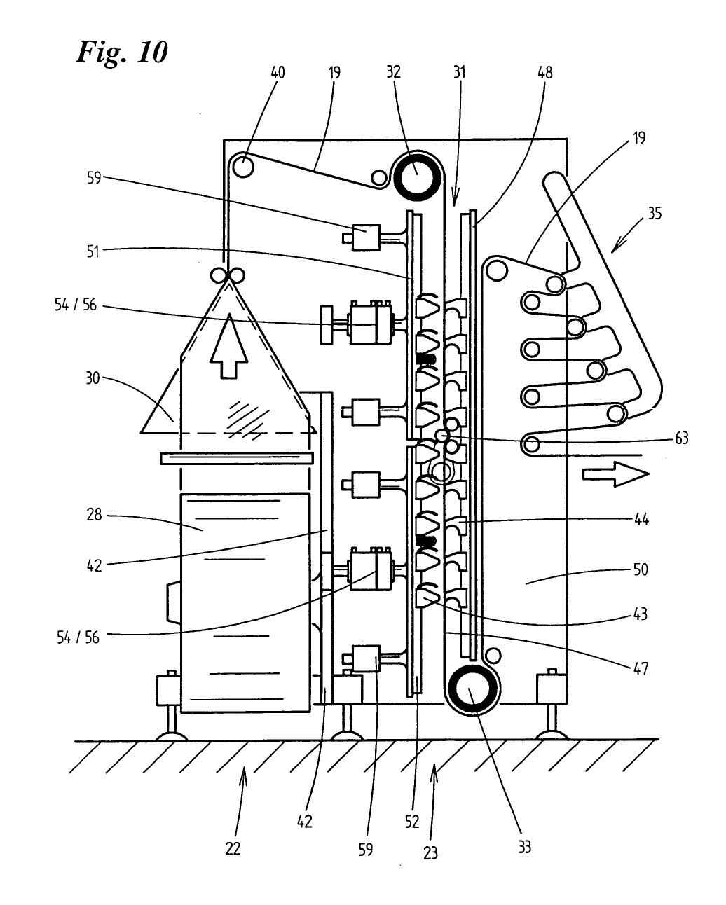

If, in the case of certain materials for producing the bags 10, it is possible to dispense with cooling and a particularly compact construction is desired, the top and bottom deflecting rollers 32 and 33 are designed directly as drive rollers (driven by servo motors), it being possible to do away with the otherwise offset top and bottom drive rollers (FIG. 5). Instead, in the case of the exemplary embodiment of FIG. 10, the web 19 is guided over a single deflecting roller following the sheet-material station 22 and/or the folding device 30. Equally, it is likewise the case that the compensating pendulum arrangement 35, following the sealing subassembly 31, is assigned a single deflecting roller 34. In the case of this simpler solution, it is also possible to dispense with the cooling plate 71 shown in FIG. 8.

### LIST OF DESIGNATIONS

10 Bag
11 Pocket
12 Front pocket wall
13 Rear pocket wall
14 Side seam
15 Side seam
16 Opening
17 Fold-over flap
18 Tape
19 Web
20 Web leg
21 Connecting seam
22 Sheet-material station
23 Sealing station
24 Tape station
25 Severing station
26 Transfer station
27 Filling and closing station
28 Reel
29 Compensating pendulum arrangement
30 Folding device
31 Sealing subassembly
32 Deflecting roller
33 Deflecting roller
34 Deflecting roller
35 Compensating pendulum arrangement
36 Bag conveyer
37 Transfer device
38 Bag turret
39 Removal conveyer
40 Deflecting roller
41 Servo motor
42 Carrying wall
43 Sealing jaw
44 Abutment jaw
45 Sealing surface
46 Abutment surface
47 Web portion
48 Carrier
49 Connecting rail
50 Main plate
52 Jaw carrier
53 Connecting rail
55 Holder
56 Additional cylinder
51 Jaw carrier
54 Actuating cylinder
57 Guide rod
58 Guide rod
59 Guide
60 Printed marks
61 Printed-mark reader
62 Printed-mark reader
63 Compensating roller
64 Abutment roller
65 Abutment roller
66 Spring
67 Lever
68 Cylinder
69 Piston
70 Protective shield
71 Cooling plate

What is claimed is:

1. A process for producing tobacco bags (10) from sheet material having a pocket (11) which is formed by folding, is bounded by side seams (14, 15) and has an opening (16) and a closure flap (17), comprising, in order to produce the bags (10):
folding over a continuous sheet-material web (19) in the longitudinal direction to form a web leg (20), then
providing the web (19) with transversely directed connecting seams (21) in the region of the web leg (20), the connecting seams (21) being provided in the region of an upright portion (47) of the web (19) by sealing devices (43, 44) arranged one above the other, and then
severing the bags (10) from the web (19) by transversely directed severing cuts in the region of the connecting seams (21).

2. The process according to claim 1, wherein the web (19) having the web leg (20) is deflectable, via a top deflection, into the upright web portion (47) and is conveyed downwards through a region of the sealing devices (43, 44) to a bottom deflection, the transversely directed connecting seams (21) being produced during a standstill phase in the region of the upright web portion (47).

3. The process according to claim 1, wherein the web (19) is folded continuously to form the web leg (20) by a stationary folding device (30) during an essentially upward transporting movement and is then deflected into an essentially horizontal conveying section.

4. The process according to claim 1, wherein the web (19) is guided in a largely tensioning-free manner in the region of a sealing subassembly (31) and is controlled by stationary sensors or printed-mark readers (61, 62) in conjunction with printed marks (60) provided on the web (19).

5. An apparatus for producing tobacco bags (10) from sheet material having a pocket (11) formed by folding, having side seams (14, 15) in the region of the pocket (11) and having an opening (16) in this pocket, wherein a sheet-material web (19) is folded over continuously in the longitudinal direction to form a web leg (20) by a stationary folding device (30), transversely directed connecting seams (21) are produced on the web leg (20) in the region of a sealing subassembly (31) and, finally, in the region of a severing station (25), the bags (10) are severed from the web (19) by transversely directed severing cuts in the region of the connecting seams (21), comprising an upright sealing subassembly (31) having a plurality of transversely moveable sealing devices (43) that are arranged one above the other and provide the connecting seams (21) during a temporary standstill of the web (19).

6. The apparatus according to claim 5, further comprising deflecting rollers (32, 33) for the web (19) on a top inlet side of the sealing subassembly (31) and a deflecting roller (33) on an outlet side correspondingly positioned to deflect the web (19) into a vertical plane, whereby, in the region of the sealing subassembly (31), the web (19) forms an upright web portion (47) that, during the standstill phase for the purpose of providing the connecting seams (21), runs in a largely tensioning-free manner in the vertical plane.

7. The apparatus according to claim 5, wherein the sealing subassembly (31) comprises a plurality of transversely directed, bar-like sealing devices, heated sealing jaws (43) on one side and abutment jaws (44) on another side of the web (19), wherein the sealing devices, for the purpose of providing the connecting seams (21), are moved relative to one another until they butt against the web (19), such that the sealing jaws (43) are moved towards the fixed abutment jaws (44) and/or the web (19).

8. The apparatus according to claim 7, wherein the sealing devices, the sealing jaws (43) on the one hand and/or the abutment jaws (44) on the other hand, are provided in an adjustable manner in each case on upright carrying devices, on a carrier (48) for the abutment jaws (44) and on jaw carriers (51, 52) for the sealing jaws (43), wherein, for the purpose of actuating the sealing devices, for the carrying devices, or a carrying device with the sealing devices provided thereon, to be moved back and forth in the horizontal direction.

9. The apparatus according to claim 8, wherein the carrying devices are plate-like in structure and have two spaced-apart connecting rails (49, 53) as retaining devices for the releasable and displaceable fastening of the sealing devices (43, 44).

10. The apparatus according to claim 8, wherein the heated sealing jaws (43) are provided on a plurality of jaw carriers (51, 52) which are arranged one above the other, and are aligned in the same plane, each jaw carrier (51, 52) being movable transversely by a horizontal actuating device (54) in conjunction with an additional cylinder (56) for moving the jaw carriers (51, 52) into a retracted rest position, in which they are spaced apart from the web (19).

11. The apparatus according to claim 5, further comprising cooling means arranged in the region of the sealing subassembly (31) for cooling the web (19) once the connecting seams (21) have been provided, the cooling means comprising a cooled bottom deflecting roller (33) and/or a cooling device (71) extending in the movement direction of the web (19), immediately following the sealing subassembly (31), arranged in an upright manner on the free rear side of the sealing subassembly (31).

12. The apparatus according to claim 5, wherein the heated sealing jaws (43) are assigned moveable shielding devices which can be moved into a position between the sealing devices or sealing jaws (43) and the web (19) in order to prevent or reduce the transmission of undesired heat to the web, the shielding devices being curved, pivotable protective shields (70) for each sealing jaw (43).

13. The apparatus according to claim 5, further comprising printed-mark readers (61, 62) arranged in the region of the sealing subassembly (31), wherein the printed-mark readers (61, 62) precisely controlling the web (19) in the region of the web portion (47) by sensing printed marks (60) on the web (19), the printed-mark readers (61, 62) being installed at approximately equal spacings from the top deflecting roller (32), on the one hand, and the bottom deflecting roller (33), on the other hand.

14. The apparatus according to claim 5, wherein the web (19), in the region of the sealing subassembly (31), is controlled in respect of transportation by deflecting rollers (32, 33) with a servo drive in the region of the sealing subassembly (31), a first deflecting roller (32) being in the inlet region of the sealing subassembly (31) and/or a further deflecting roller (33) being in the outlet region of the sealing subassembly (31).

15. The apparatus according to claim 5, further comprising a compensating device arranged in the region of the sealing subassembly (31), half-way up between adjacent sealing devices arranged one above the other, in order to compensate for incorrect positioning of the web (19) in the region of the sealing subassembly (31), the compensating device comprising a compensating roller (63) which is movable transversely to the web (19) in order to increase the web tensioning and/or to deflect the web (19), wherein the compensating roller (63) is moved into a compensating position on the web (19) and then for the sealing devices or sealing jaws (43) to be moved into a sealing position with abutment against the web (19).

16. The apparatus according to claim 15, wherein the compensating device comprises a movable compensating roller (63) and two spaced-apart, fixed abutment rollers (64, 65) on the opposite side of the web (19).

17. An apparatus for producing tobacco bags (10) from sheet material having a pocket (11) formed by folding, having side seams (14, 15) in the region of the pocket (11) and having an opening (16) in this pocket, wherein a sheet-material web (19), drawn off from a reel (28), is directed via a folding device (30) for the purpose of providing a continuous web leg (20), for the web (19) to be directed through a sealing station (23) with a sealing subassembly (31) and then, in the region of a severing station (25), for bags (10) to be severed from the web (19) and fed to a bag turret (38), comprising:
a) a sheet-material station (22) with a reel (28) and deflecting rollers positioned transversely to a main conveying direction of the web (19), the reel (28) having an axis of rotation oriented in the main conveying direction,
b) in the region of the folding device (30), for the purpose of forming a web leg (20), means for deflecting the web (19) into the main conveying direction and feeding the web (19) to the sealing station (23) with a sealing subassembly (31),
c) in the region of the sealing subassembly (31), which is arranged in an upright plane, means for transporting the web (19) through the sealing subassembly (31) from top to bottom,
d) following the sealing subassembly (31), means for directing the web (19) provided with connecting seams (21) through the severing station (25) with a severing blade for severing the bags (10) and for depositing the same on a following bag conveyer (36),
e) transfer devices provided on the bag conveyer (36) for gripping a plurality of bags (10) and feeding the bags (10) to the bag turret (38), which is arranged above, and in an offset manner in relation to, the bag conveyer (36), and
f) the bag turret (38) is rotated about an axis which extends in the main conveying direction.
